(19) United States
(12) Patent Application Publication
(10) Pub. No.: US 2025/0286646 A1
(43) Pub. Date: Sep. 11, 2025

(54) Electronic Apparatus for Jamming and Operation Method Thereof

(71) Applicant: AGENCY FOR DEFENSE DEVELOPMENT, Daejeon (KR)

(72) Inventors: Jung Hoon LEE, Daejeon (KR); Seung Ho CHOI, Daejeon (KR); Byung Koo PARK, Daejeon (KR); Je Il JO, Daejeon (KR)

(21) Appl. No.: 18/598,494

(22) Filed: Mar. 7, 2024

(30) Foreign Application Priority Data
Mar. 7, 2024 (KR) 10-2023-0147737

(51) Int. Cl. H04K 3/00

(52) U.S. Cl. CPC H04K 3/45; H04K 3/226; H04K 3/825

(57) ABSTRACT

Provided is an electronic apparatus for jamming, the apparatus including a receiver that sequentially receives a first signal and a second signal, a signal analyzer that analyzes the first signal and detects a threat signal in a first frequency band, a controller that controls a jamming resource to generate a jamming signal corresponding to the threat signal in the first frequency band, a transmitter that transmits the jamming signal, and a signal detector that identifies, after the jamming signal is transmitted, whether the threat signal is present in the first frequency band from the second signal while the signal analyzer identifying whether the threat signal is present in a second frequency band by analyzing the first signal or the second signal.

### PRIORITY INFORMATION

This application claims the benefit of Korean Patent Application No. 10-2023-0147737, filed on Oct. 31, 2023, in the Korean Intellectual Property Office, the disclosure of which is incorporated herein by reference in its entirety.

### FIELD OF THE INVENTION

The example embodiments relate to systems, apparatuses, methods, and instructions for jamming. More specifically, the example embodiments detect a threat signal from a signal received through a receiver, perform jamming on a detected threat signal, and determine the effectiveness of jamming through a signal detector, in electronic warfare (EW).

### DISCUSSION OF THE RELATED ART

The EW is a military activity in which threat radio signals are detected, tracked, analyzed and transmitted to ally forces in a battlefield environment, and using the collected information, ally forces are protected, and the enemy's radar and communications are paralyzed, enabling successful operation of the ally forces.

The EW may generally be subdivided into electronic support (ES), electronic attack (EA) and electronic protection (EP). The ES is receiving threat signals and performing analysis on the threat signals. The EA is attempting to eliminate threats by transmitting noise and deception signals in response to the threat signals. The EP is conducting defense corresponding to the EA. Generally, the ES and the EA are performed in the EW, and the EP is performed on the radar. Further, the EA is not performed in isolation, and signals are received and analyzed through the ES, and the EA is performed on signals deemed as threats.

In the EA, jamming resources are utilized to transmit noise and deception signals in response to the threat signals. The jamming resources may include a noise generator, a digital radio frequency memory (DRFM) for generating deception signals and a doppler signal generating apparatus for velocity deception against anti-aircraft threats.

Meanwhile, it is important for an EW system to determine the success of EA technology in the case of receiving and analyzing threat signals through the ES and performing the EA such as jamming to respond to the threats. A receiver of the EW system receives signals in a frequency range other than the jamming frequency range to respond to multiple threat signals in a wide bandwidth. Further, while jamming a threat signal of a specific frequency, the EW system may be unable to receive the frequency of the threat signal due to the jamming signal. For this reason, the EW system may temporarily stop transmitting jamming signals and use a look-through technique to determine the effectiveness of jamming depending on whether the threat signal is received. The look-through technique may be performed as shown in FIG. 1.

In order to respond to broadband multiple threat signals, such existing EW systems receive and analyze signals in other frequency ranges other than the jamming frequency range, and then determine jamming effectiveness through the look-through technique, and thus the existing EW systems have the disadvantage of having to re-search the jamming frequency range. Further, when a threat of a different frequency range exists during the re-search, the existing EW systems have no choice but to receive and analyze a threat signal of the different frequency range late, and thus there is a problem in that the response time to the threat also is delayed.

Prior art documents related to the present disclosure include Republic of Korea Patent Nos. 10-1052034 and 10-2194908.

### SUMMARY OF THE INVENTION

An aspect provides an electronic apparatus for jamming that includes a separate signal detecting part that identifies the presence of a threat signal in the frequency range where jamming is being performed while a signal analyzing part, which detects threat signals from received signals, searches for threat signals in different frequency ranges, and thus the electronic apparatus efficiently responding to multiple broadband threat signals without stopping the search for threat signals in other frequency ranges or stopping the transmission of jamming signals, and provides an operation method of the electronic apparatus.

For those of ordinary skill in the art to which the present disclosure pertains, various substitutions, modifications and changes are possible within the scope of the example embodiments without departing from the technical spirit of the example embodiment. Thus, the present disclosure is not limited to the above-described example embodiments and the accompanying drawings.

According to an aspect, there is provided an electronic apparatus for jamming, the apparatus including a receiver that sequentially receives a first signal and a second signal, a signal analyzer that analyzes the first signal and detects a threat signal in a first frequency band, a controller that controls a jamming resource to generate a jamming signal corresponding to the threat signal in the first frequency band, a transmitter that transmits the jamming signal, and a signal detector that identifies, after the jamming signal is transmitted, whether the threat signal is present in the first frequency band from the second signal while the signal analyzer identifying whether the threat signal is present in a second frequency band by analyzing the first signal or the second signal.

According to an example embodiment, if the threat signal is not detected in the first frequency band by the signal analyzer for a predetermined period of time, the controller may be configured to determine that the jamming signal is valid and stop generating the jamming signal by controlling the jamming resource.

According to an example embodiment, if the threat signal is detected in the first frequency band by the signal analyzer, the controller may be configured to determine that the jamming signal is invalid and to change allocation of the jamming resource.

According to an example embodiment, the controller may be further configured to set a threshold value for detecting the threat signal of the signal detector based on the threat signal, and the signal detector may be further configured to output a video signal of a threat signal exceeding the threshold value from the first signal.

According to an example embodiment, the electronic apparatus may further include a frequency down converter that down-converts frequency of the first signal and transmits the first signal to the signal detector, the jamming resource that receives the threat signal detected from the signal detector, and a frequency up converter that up-converts frequency of the jamming signal generated from the jamming resource.

According to an example embodiment, the jamming resource may include a DRFM for generating a range gate pull-off/in (RGPO/I) signal based on the threat signal detected by the signal detector.

According to an example embodiment, the jamming resource may include a doppler signal generating apparatus for generating a VGPO/I signal based on the threat signal detected from the signal detector.

According to an example embodiment, the jamming resource may include a noise generating apparatus.

According to another aspect, there is provided an operation method of an electronic apparatus for jamming, the method including receiving a first signal, analyzing the first signal and detecting a threat signal in a first frequency band, controlling a jamming resource to generate a jamming signal corresponding to the threat signal in the first frequency band, transmitting the jamming signal, and while identifying whether the threat signal is present in a second frequency band by analyzing the first signal or a second signal that is received after the first signal, identifying whether the threat signal is present in the first frequency band from the second signal.

According to another aspect, there is provided a non-transitory computer-readable recording medium having recorded thereon a program for executing an operation method of an electronic apparatus for jamming on a computer, wherein the operation method comprises receiving a first signal, analyzing the first signal and detecting a threat signal in a first frequency band, controlling a jamming resource to generate a jamming signal corresponding to the threat signal in the first frequency band, transmitting the jamming signal, and while identifying whether the threat signal is present in a second frequency band by analyzing the first signal or a second signal that is received after the first signal, identifying whether the threat signal is present in the first frequency band from the second signal.

Additional aspects of example embodiments will be set forth in part in the description which follows and, in part, will be apparent from the description, or may be learned by practice of the disclosure.

According to example embodiments, it is possible to efficiently respond to multiple broadband threat signals without stopping the search for threat signals in other frequency ranges or stopping the transmission of jamming signals, by an electronic apparatus having a separate signal detecting part that identifies the presence of a threat signal in the frequency range where jamming is being performed while a signal analyzing part, which detects threat signals from received signals, searches for threat signals in different frequency ranges.

Effects of the present disclosure are not limited to those described above, and other effects may be made apparent to those skilled in the art from the following description.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 is a diagram schematically showing each element of an electronic apparatus for jamming according to an example embodiment;

FIG. 2 shows a general look-through technique for jamming according to an example embodiment;

FIG. 3 is a diagram schematically showing elements and connection relationships of each element of an electronic apparatus for jamming according to an example embodiment;

FIG. 4 is a diagram schematically showing elements and connection relationships of each element of an electronic apparatus for jamming according to an example embodiment;

FIG. 5 is a diagram illustrating a operation process of a signal detector that outputs a video signal for a threat signal according to an example embodiment;

FIG. 6 is a flowchart showing flow of a method for jamming of an electronic apparatus according to an example embodiment; and

FIG. 7 is a flowchart showing flow of a method of an electronic apparatus jamming according to an example embodiment.

### DETAILED DESCRIPTION OF THE EXAMPLE EMBODIMENTS

Hereinafter, example embodiments of the present disclosure will be described in detail with reference to the accompanying drawings.

In describing the example embodiments, descriptions of technical contents that are well known in the technical field to which the present disclosure pertains and that are not directly related to the present disclosure will be omitted. This is to more clearly convey the gist of the present disclosure without obscuring the gist of the present disclosure by omitting unnecessary description.

For the same reason, some elements are exaggerated, omitted or schematically illustrated in the accompanying drawings. In addition, the size of each element does not fully reflect the actual size. In each figure, the same or corresponding elements are assigned the same reference numerals.

Advantages and features of the present disclosure, and a method of achieving the advantages and the features will become apparent with reference to the example embodiments described below in detail together with the accompanying drawings. However, the present disclosure is not limited to the example embodiments disclosed below, and may be implemented in various different forms. The example embodiments are provided to describe the present disclosure, and inform those of ordinary skill in the art to which the present disclosure pertains. Like reference numerals refer to like elements throughout.

In this case, it will be understood that each block of a flowchart diagram and a combination of the flowchart diagrams may be performed by computer program instructions. The computer program instructions may be embodied in a processor of a general-purpose computer or a special purpose computer, or may be embodied in a processor of other programmable data processing equipment. Thus, the instructions, executed via a processor of a computer or other programmable data processing equipment, may generate a part for performing functions described in the flowchart blocks. To implement a function in a particular manner, the computer program instructions also may be stored in a computer-usable or computer-readable memory that may direct a computer or other programmable data processing equipment. Thus, the instructions stored in the computer usable or computer readable memory may be produced as an article of manufacture containing an instruction part for performing the functions described in the flowchart blocks. The computer program instructions may be embodied in a computer or other programmable data processing equipment. Thus, a series of operations may be performed in a computer or other programmable data processing equipment to create a computer-executed process, and the computer or other programmable data processing equipment may provide steps for performing the functions described in the flowchart blocks.

Additionally, each block may represent a module, a segment, or a portion of code that includes one or more executable instructions for executing a specified logical function(s). It should also be noted that in some alternative implementations the functions recited in the blocks may occur out of order. For example, two blocks shown one after another may be performed substantially at the same time, or the blocks may sometimes be performed in the reverse order according to a corresponding function.

In this case, the term “˜ part” used in the example embodiments refers to software or hardware components such as a field programmable gate array (FPGA) or an application specific integrated circuit (ASIC) and performs predetermined roles. However, the term “˜ part” does not have a meaning limited to software or hardware. The “˜ part” may be formed to be stored in an addressable storage medium or to reproduce one or more processors. Thus, as an example, the “˜ part” includes components such as software components, object-oriented software components, class components, and task components, and processes, functions, attributes, procedures, sub-routines, segments of a program code, drivers, firmware, micro-codes, circuits, data, database, data structures, tables, arrays, and variables. The functions provided in the components and the “˜ part” may be combined into a smaller number of components and “˜ parts” or may be further divided into additional components and “˜ parts.” In addition, the components and the “˜ parts” may be implemented to reproduce one or more central processing units (CPUs) in a device or a secure multimedia card.

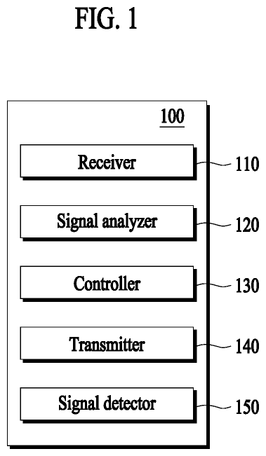

FIG. 1 is a diagram schematically showing each element of an electronic apparatus for jamming according to an example embodiment.

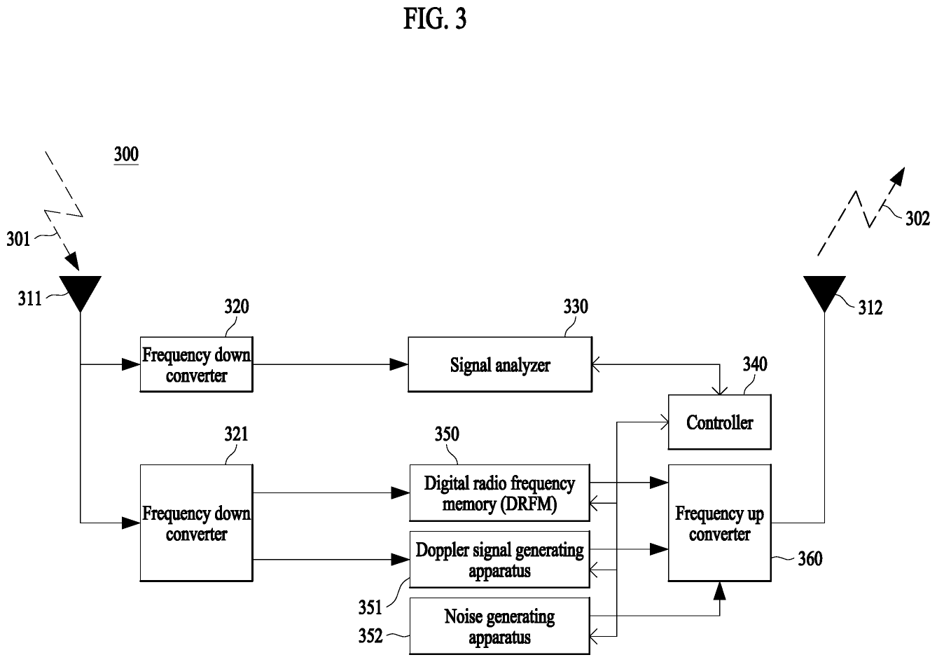

Referring to FIG. 1, an electronic apparatus 100 for jamming according to an example embodiment may include a receiver 110, a signal analyzer 120, a controller 130, a transmitter 140, and a signal detector 150. Specifically, the electronic apparatus 100 for jamming may include the receiver 110 that sequentially receives a first signal and a second signal, the signal analyzer 120 that analyzes the first signal and detects a threat signal in the first frequency band, the controller 130 that controls jamming resources to generate a jamming signal corresponding to the threat signal in the first frequency band, the transmitter 140 that transmits the jamming signal, and the signal detector 150 that identifies, after the jamming signal is transmitted, whether the threat signal in the first frequency band exists from the second signal while the signal analyzer 120 identifying whether the threat signal in the second frequency band exists by analyzing the first signal or the second signal. A more detailed description, including the connection relationship of each element of the electronic apparatus 100, will be described later with reference to FIGS. 3 to 5.

Meanwhile, the electronic apparatus 100 illustrated in FIG. 1 shows only elements related to the example embodiments, and thus it is apparent to those skilled in the art that the electronic apparatus 100 may further include other general-purpose elements in addition to the elements shown in FIG. 1.

According to an example embodiment, the electronic apparatus 100 may further include a processor and a memory. The processor serves to control overall functions for jamming in the electronic apparatus 100. For example, the processor generally controls the electronic apparatus 100 by executing programs stored in the memory in the electronic apparatus 100. The processor may be implemented as a central processing unit (CPU), a graphics processing unit (GPU) or an application processor (AP) included in the electronic apparatus 100. However, the processor is not limited thereto. The memory is hardware for storing various data processed in the electronic apparatus 100, and the memory may store data processed and data to be processed by the electronic apparatus 100. Further, the memory may store applications to be driven by the electronic apparatus 100 and drivers. The memory may include random access memory (RAM), such as dynamic random access memory (DRAM), static random access memory (SRAM), read-only memory (ROM), electrically erasable programmable read-only memory (EEPROM), CD-ROM, Blu-ray or other optical disk storage, hard disk drive (HDD), solid state drive (SSD) or flash memory.

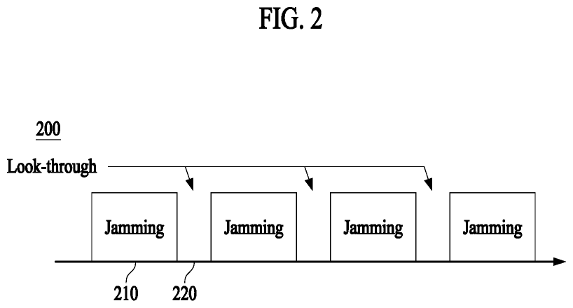

FIG. 2 shows a general look-through technique 200 for jamming according to an example embodiment.

In an example embodiment, a receiver of an EW system searches for threats from received signals in frequency ranges other than the jamming frequency range in order to respond to multiple threat signals in a wide band. Further, while the EW system is performing jamming on a specific threat frequency, it may be impossible to receive and search for the threat signal at that frequency due to feedback from its own jamming signal. For the two reasons, the EW system according to an example embodiment may perform a look-through technique to determine the effectiveness of the jamming signal. In other words, referring to FIG. 2, the look-through time period for jamming is divided into the transmission range of a jamming signal 210 and the transmission interruption range of a jamming signal 220. In the transmission interruption range 220 of the jamming signal, the EW system may determine jamming effectiveness depending on whether the threat signal is received. As such, the existing EW system according to an example embodiment uses a look-through technique to stop jamming signal transmission for a certain period of time and identify whether the threat signal still exists in order to determine whether the jamming signal transmission is successful, and thus the EW system has the disadvantage of not being able to continuously carry out electronic attacks.

FIG. 3 is a diagram schematically showing elements and connection relationships of each element of an electronic apparatus for jamming according to an example embodiment. Referring to FIG. 3, an electronic apparatus 300 for jamming according to an example embodiment is shown.

In an example embodiment, the electronic apparatus 300 may include a receiver 311, a transmitter 312, frequency down converters 320 and 321, a signal analyzer 330, a controller 340, jamming resources which are a DRFM 350, a doppler signal generating apparatus 351 and a noise generating apparatus 352, and a frequency up converter 360. A signal 301 received by the receiver 311 may be converted to an intermediate frequency through the frequency down converter 320 and transmitted to the signal analyzer 330. Here, with respect to the received signal 301, a plurality of signals may be received sequentially, such as a first signal, a second signal, a third signal and so on. The frequency down converter 320 may divide a received signal with a wide bandwidth (for example, 2 to 18 GHz) into a plurality of sub-bands with a small bandwidth (for example, 500 MHz bandwidth), and may convert the signal of each sub-band into an intermediate frequency and transmit the signal to the signal analyzer 330.

In an example embodiment, the signal analyzer 330 may detect threat signals by sequentially analyzing received signals according to a set schedule for a plurality of frequency bands. For example, the signal analyzer 330 may detect a threat signal in the first frequency band by analyzing the first signal received through the receiver 311.

In an example embodiment, if a threat signal in the first frequency band is detected in the signal analyzer 330, the controller 340 may control the at least one of the jamming resources which are the DRFM 350, the doppler signal generating apparatus 351 and the noise generating apparatus 352 to generate a jamming signal corresponding to the threat signal in the first frequency band. Jamming used in the EW may include noise technique and deception technique. The noise technique may be performed by the noise generating apparatus 352, and the deception technique may be performed as range deception or velocity deception by the DRFM 350 and the doppler signal generating apparatus 351. Meanwhile, various jamming techniques, such as angular jamming and complex jamming, as well as noise and deception techniques, may be performed through various jamming resources.

In an example embodiment, the DRFM 350 may digitize and store enemy radar signals that transmit and receive same-phase radio waves, restore the enemy radar signals to the same phase, and transmit a jamming signal. The DRFM 350 may extract the phase by high-speed sampling and A/D conversion of an input high-frequency signal, digitize the phase and store a digitized signal in memory. The DRFM 350 may output a jamming signal by applying techniques such as time delay, frequency shift or noise generation after D/A conversion of the stored digital signal when a high-frequency signal is needed. In an example embodiment, the DRFM 350 may generate an RGPO/I signal based on the threat signal to deceive the range of the radar and a target.

In an example embodiment, the doppler signal generating apparatus 351 may gradually increase or decrease the doppler frequency of the threat radar target reflection signal and radiates the signal with high power, and block the tracking by allowing the radar's velocity gate to track the deceptive jamming signal. In an example embodiment, the doppler signal generating apparatus 351 may generate a VGPO/I signal based on the threat signal to deceive the threat signal from detecting the velocity of the target.

In an example embodiment, the noise generating apparatus 352 may perform noise technique that radiates an interference signal, such as white noise, in the direction of an enemy radar so that the target's reflected signal is disturbed by the interference signal.

In an example embodiment, the jamming signal generated through at least one of the jamming resources which are the DRFM 350, the doppler signal generating apparatus 351 and the noise generating apparatus 352 may be up-converted in frequency through the frequency up converter 360 and output as a jamming signal 302 through the transmitter 312.

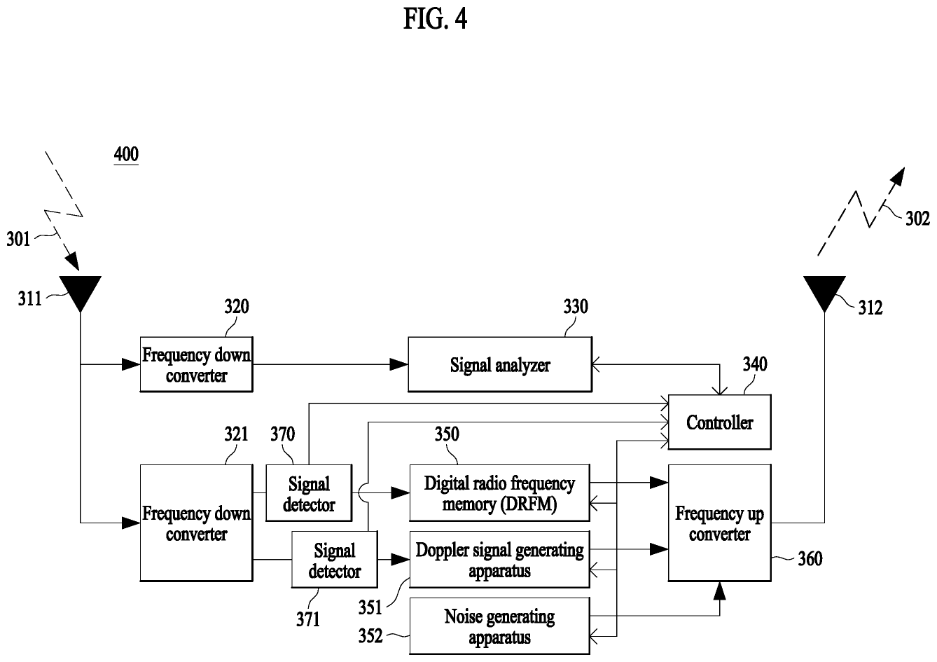

Meanwhile, in order to respond to broadband multiple threat signals, the electronic apparatus according to the example embodiment illustrated in FIG. 3 receives and analyzes signals in other frequency ranges other than the jamming frequency range, and then determines jamming effectiveness through the look-through technique, and thus the electronic apparatus has the disadvantage of having to re-search the jamming frequency range. Further, when a threat of a different frequency range exists during the re-search, the electronic apparatus has no choice but to receive and analyze a threat signal of the different frequency range late, and thus there is a problem in that the response time to the threat is also delayed. In order to resolve the problem, an electronic apparatus as shown in FIG. 4 below may be considered.

FIG. 4 is a diagram schematically showing elements and connection relationships of each element of an electronic apparatus for jamming according to an example embodiment. Referring to FIG. 4, an electronic apparatus 400 for jamming according to an example embodiment is shown.

According to an example embodiment, the electronic apparatus 400 may include the receiver 311, the transmitter 312, the frequency down converters 320 and 321, the signal analyzer 330, the controller 340, the jamming resources which are the DRFM 350, the doppler signal generating apparatus 351 and the noise generating apparatus 352, the frequency up converter 360 and signal detectors 370 and 371. The electronic apparatus 400 of FIG. 4 may be considered as the signal detectors 370 and 371 added to the electronic apparatus 300 of FIG. 3. As illustrated in FIG. 4, the signal detectors 370 and 371 may be disposed between the frequency down converter 321 and the jamming resources (the DRFM 350 and the doppler signal generating apparatus 351).

In an example embodiment, after the jamming signal 302 is transmitted, while the signal analyzer 330 analyzes a first signal or a second signal to identify whether a threat signal in the second frequency band exists, the signal detectors 370 and 371 may identify whether a threat signal in the first frequency band exists from the second signal. The signal detectors 370 and 371 may receive a signal from the frequency down converter 321 and identify whether a threat signal exists, and if the threat signal is detected, the signal detectors 370 and 371 may transmit information about the threat signal to the jamming resources which are the DRFM 350 and the doppler signal generating apparatus 351 and to the controller 340.

In an example embodiment, the signal detectors 370 and 371 may include a video detection apparatus, and if a video signal exceeding a threshold value is detected for a threat signal in a specific frequency range received from the frequency down converter 321, the signal detectors 370 and 371 may transmit the detected video signal to the controller 340. For example, even after the jamming signal 302 is transmitted for the threat signal in the first frequency band, if the threat signal in the first frequency band is still detected through the signal detectors 370 and 371, the jamming signal 302 may be invalid, and thus the controller 340 may take steps to adjust the strength and transmission time of the jamming signal 302 or allocate other jamming resources. Meanwhile, after the jamming signal 302 is transmitted against the threat signal in the first frequency band, if the threat signal in the first frequency band is not detected for a certain period of time through the signal detectors 370 and 371, the jamming signal 302 may be valid, and thus the controller 340 may determine that jamming is no longer necessary and stop transmitting the jamming signal 302. The operation of the signal detectors 370 and 371 also may be performed while the signal analyzer 330 identifies the presence or absence of a threat signal in the second frequency band for the received signal.

As such, even while the signal analyzer 330 searches frequency bands other than the jamming frequency range to respond to multiple threat signals in the wideband, without the need to re-search the jamming frequency range to determine jamming effectiveness, the electronic apparatus 400 may determine whether a threat signal is received based on the signal transmitted from the signal detectors 370 and 371 to the controller 340. In other words, the electronic apparatus 400 allows the signal detectors 370 and 371 to partially take over the role of the existing signal analyzer 330 so that the signal analyzer 330 may continuously search for multiple threat signals without having to stop transmitting a jamming signal in an existing jamming frequency range or searching for a threat signal in another frequency range to determine the effectiveness of the jamming signal, and thus the electronic apparatus 400 enables time-efficient and resource-efficient search for threat signals, and may effectively shorten the detection and response time for threat signals.

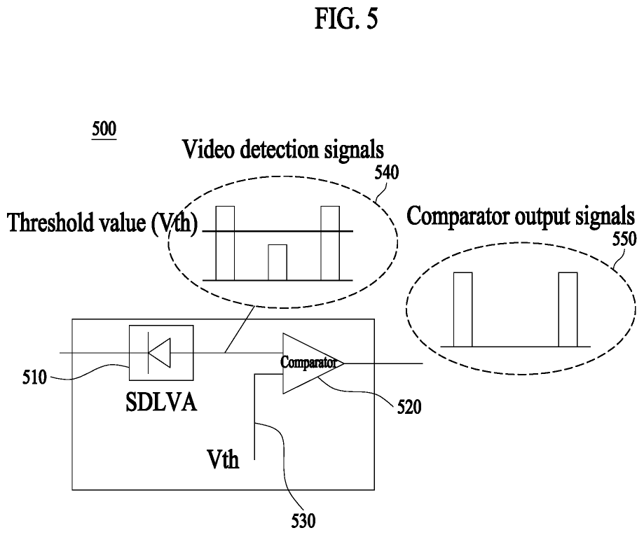

FIG. 5 is a diagram illustrating the operation process of a signal detector that outputs a video signal for a threat signal according to an example embodiment.

Referring to FIG. 5, a signal detector 500 may include a successive detection logarithmic video amplifier (SDLVA) 510 and a comparator 520. In an example embodiment, a controller may set a threshold value 530 for detecting a threat signal of the signal detector 500 based on the threat signal, and the signal detector 500 may output a video signal 550 of a threat signal exceeding the threshold value 530 from a received signal 540. Since signals other than threat signals may flow from the frequency down converter, in the signal detector 500, it may be controlled that for signals that pass the SDLVA 510, only signals exceeding the threshold value 530 are output through the comparator 520. In an example embodiment, the threshold value 530 may be set to the threshold voltage (Vth), the controller may set the initial threshold voltage to prevent false alarms based on the voltage magnitude of the threat signal, and the threshold voltage may be adaptively changed depending on the detected threat signal and the jamming signal.

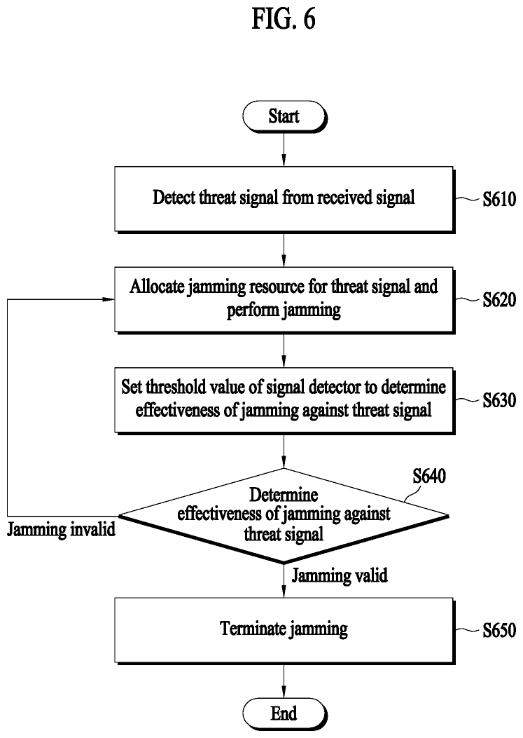

FIG. 6 is a flowchart 600 showing flow of a method for jamming of an electronic apparatus according to an example embodiment. An entity performing each operation shown in FIG. 6 may include the electronic apparatus 100 illustrated in FIG. 1, and descriptions that overlap with the description above may be omitted below.

In operation S610, the electronic apparatus may detect a threat signal from a received signal. The signal may be received through a receiver of the electronic apparatus and input into a signal analyzer, and the signal analyzer may determine whether the received signal is a threat signal by analyzing the received signal.

In operation S620, the electronic apparatus may allocate jamming resources for the threat signal and perform jamming. If the signal received through signal analysis is determined to be a threat signal, the signal analyzer of the electronic apparatus may deliver information about the threat signal to the controller. The controller may control the jamming resources to generate a jamming signal corresponding to the threat signal based on the threat signal. For example, the controller may use a doppler signal generating apparatus to transmit velocity deception signals (e.g., VGPO/I signals) to prevent the threat signal from detecting the velocity of a target, or may use a DRFM to transmit range deception signals (e.g., RGPO/I signals) to deceive the range of the laser and a target.

In operation S630, the electronic apparatus may set a threshold value of the signal detector to determine the effectiveness of jamming for the threat signal. In order to respond to a broadband threat signal, the electronic apparatus may perform jamming in response to a threat signal in the first frequency band, and the electronic apparatus may receive and analyze signals in a frequency band other than the first frequency band (for example, a second frequency band) through the signal analyzer. At the same time, the controller may control the threshold value of the signal detector to determine the effectiveness of jamming for the jamming frequency band (in other words, the first frequency band). In an example embodiment, the signal received by the receiver of the electronic apparatus may be input to the signal detector through a frequency down converter. Here, since signals other than threat signals may be introduced, the signal detector may be controlled to output only signals equal to or above the threshold controlling value through a comparator for signals that passed the SDLVA.

In operation S640, the electronic apparatus may determine the effectiveness of jamming against the threat signal. After jamming the threat signal, the signal analyzer may search for frequency bands other than the first frequency band that is currently subject to jamming in order to respond to multiple threat signals. If the threat signal is continuously tracking the target while the signal analyzer searches for a frequency band other than the first frequency band subject to jamming, the signal detector may detect a video signal corresponding to the threat signal and transmit the video signal to the controller. If jamming of the electronic apparatus is successful, the threat signal would fail to track the target, so the signal detector of the electronic apparatus would not detect video for a certain period of time, and there would be no video signal transmitted to the controller. Therefore, jamming may be determined to be successful if there is no video signal input to the controller from the signal detector of the electronic apparatus for a set period of time after transmission of the jamming signal.

In an example embodiment, if the threat signal in the first frequency band is not detected for a certain period of time through the signal analyzer, the controller may be configured to determine that the jamming signal is valid and stop generating the jamming signal by controlling the jamming resources. If the electronic apparatus determines that jamming of the threat signal is effective, in operation S650, the electronic apparatus may terminate jamming. If a video signal is not input from the signal detector to the controller for a set period of time after transmission of the jamming signal, jamming may be determined as being successful, and the jamming may finally be terminated by stopping the transmission of jamming signals to the target threat. In an example embodiment, the set period of time may be adaptively changed depending on the threat signal receiving history, the jamming performance history of the jamming resources and types of available jamming resources.

However, in an example embodiment, if a threat signal in the first frequency band is detected through the signal analyzer, the controller may be configured to determine that the jamming signal is invalid and to change the allocation of jamming resources. If the video signal is continuously transmitted from the signal detector to the controller even after transmission of the jamming signal, the jamming signal may be determined to be invalid for the threat signal. If the jamming signal is determined to be invalid, the electronic apparatus may return to operation S620 and perform jamming again by allocating new jamming resources.

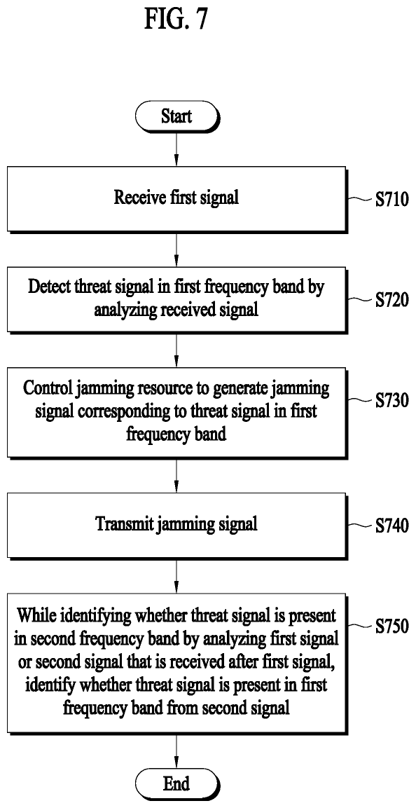

FIG. 7 is a flowchart 700 showing flow of a method of an electronic apparatus jamming according to an example embodiment. An entity performing each operation shown in FIG. 7 may include the electronic apparatus 100 illustrated in FIG. 1, and descriptions that overlap with the description above may be omitted below.

In operation S710, the electronic apparatus may receive a first signal. Operation S710 may be performed, for example, by the receiver 110 of the electronic apparatus 100 of FIG. 1.

In operation S720, the electronic apparatus may detect a threat signal in the first frequency band by analyzing the received signal. Operation S720 may be performed, for example, by the signal analyzer 120 of the electronic apparatus 100 of FIG. 1.

In operation S730, the electronic apparatus may control jamming resources to generate a jamming signal corresponding to a threat signal in the first frequency band. Operation S730 may be performed, for example, by the controller 130 of the electronic apparatus 100 of FIG. 1.

In operation S740, the electronic apparatus may transmit jamming signals. Operation S740 may be performed, for example, by the transmitter 140 of the electronic apparatus 100 of FIG. 1.

In operation S750, while analyzing the first signal or a second signal received after the first signal to determine whether a threat signal exists in the second frequency band, the electronic apparatus may identify whether a threat signal in the first frequency band exists from the second signal. For example, analyzing the first signal or the second signal in operation S750 to determine whether a threat signal in the second frequency band exists may be performed by the signal analyzer 120 of the electronic apparatus 100 of FIG. 1, and identifying whether a threat signal in the first frequency band exists from the second signal in operation S750 may be performed by the signal detector 150 of the electronic apparatus 100 of FIG. 1.

Meanwhile, in the present disclosure and drawings, example embodiments are disclosed, and certain terms are used. However, the terms are only used to describe the technical content of the present disclosure and to help the understanding of the present disclosure, but not to limit the scope of the present disclosure. It is apparent to those of ordinary skill in the art to which the present disclosure pertains that other modifications based on the technical spirit of the present disclosure may be implemented in addition to the example embodiments disclosed herein.

The electronic apparatus according to the above-described example embodiments may include a processor, a memory for storing and executing program data, a permanent storage such as a disk drive, and/or a user interface device such as a communication port, a touch panel, a key and/or an icon that communicates with an external device. Methods implemented as software modules or algorithms may be stored in a computer-readable recording medium as computer-readable codes or program instructions executable on the processor. Here, the computer-readable recording medium includes a magnetic storage medium (for example, ROMs, RAMs, floppy disks and hard disks) and an optically readable medium (for example, CD-ROMs and DVDs). The computer-readable recording medium may be distributed among network-connected computer systems, so that the computer-readable codes may be stored and executed in a distributed manner. The medium may be readable by a computer, stored in a memory, and executed on a processer.

The example embodiments may be represented by functional block elements and various processing steps. The functional blocks may be implemented in any number of hardware and/or software configurations that perform specific functions. For example, an example embodiment may adopt integrated circuit configurations, such as memory, processing, logic and/or look-up table, that may execute various functions by the control of one or more microprocessors or other control devices. Similar to that elements may be implemented as software programming or software elements, the example embodiments may be implemented in a programming or scripting language such as C, C++, Java, assembler, Python, etc., including various algorithms implemented as a combination of data structures, processes, routines, or other programming constructs. Functional aspects may be implemented in an algorithm running on one or more processors. Further, the example embodiments may adopt the existing art for electronic environment setting, signal processing, and/or data processing. Terms such as “mechanism,” “element,” “means” and “configuration” may be used broadly and are not limited to mechanical and physical elements. The terms may include the meaning of a series of routines of software in association with a processor or the like.

It will be apparent to those skilled in the art that various modifications and variations may be made in the example embodiments of the present invention without departing from the spirit or scope of the invention. Thus, it is intended that the present invention cover the modifications and variations of this invention provided they come within the scope of the appended claims and their equivalents.

What is claimed is:

1. An electronic apparatus for jamming, the apparatus comprising:
a receiver that sequentially receives a first signal and a second signal;
a signal analyzer that analyzes the first signal and detects a threat signal in a first frequency band;
a controller that controls a jamming resource to generate a jamming signal corresponding to the threat signal in the first frequency band;
a transmitter that transmits the jamming signal; and
a signal detector that identifies, after the jamming signal is transmitted, whether the threat signal is present in the first frequency band from the second signal while the signal analyzer identifying whether the threat signal is present in a second frequency band by analyzing the first signal or the second signal.

2. The electronic apparatus of claim 1, wherein if the threat signal is not detected in the first frequency band by the signal analyzer for a predetermined period of time, the controller determines whether the jamming signal is valid and stops generating the jamming signal by controlling the jamming resource.

3. The electronic apparatus of claim 1, wherein if the threat signal is detected in the first frequency band by the signal analyzer, the controller determines that the jamming signal is invalid and changes allocation of the jamming resource.

4. The electronic apparatus of claim 1, wherein the controller sets a threshold value for detecting the threat signal of the signal detector based on the threat signal, and
wherein the signal detector outputs a video signal of a threat signal exceeding the threshold value from the first signal.

5. The electronic apparatus of claim 1, further comprising:
a frequency down converter that down-converts frequency of the first signal and transmits the first signal to the signal detector;
the jamming resource that receives the threat signal detected from the signal detector; and
a frequency up converter that up-converts frequency of the jamming signal generated from the jamming resource.

6. The electronic apparatus of claim 5, wherein the jamming resource includes a digital radio frequency memory (DRFM) for generating a range gate pull-off/in (RGPO/I) signal based on the threat signal detected by the signal detector.

7. The electronic apparatus of claim 5, wherein the jamming resource includes a doppler signal generating apparatus for generating a velocity gate pull-off/in (VGPO/I) signal based on the threat signal detected from the signal detector.

8. The electronic apparatus of claim 1, wherein the jamming resource includes a noise generating apparatus.

9. An operating method of an electronic apparatus for jamming, the method comprising:
receiving a first signal;
analyzing the first signal and detecting a threat signal in a first frequency band;
controlling a jamming resource to generate a jamming signal corresponding to the threat signal in the first frequency band;
transmitting the jamming signal; and
while identifying whether the threat signal is present in a second frequency band by analyzing the first signal or a second signal that is received after the first signal, identifying whether the threat signal is present in the first frequency band from the second signal.

10. A non-transitory computer-readable recording medium having recorded thereon a program for executing an operating method of an electronic apparatus for jamming on a computer,
wherein the operating method comprises:
receiving a first signal;
analyzing the first signal and detecting a threat signal in a first frequency band;
controlling a jamming resource to generate a jamming signal corresponding to the threat signal in the first frequency band;
transmitting the jamming signal; and
while identifying whether the threat signal is present in a second frequency band by analyzing the first signal or a second signal that is received after the first signal, identifying whether the threat signal is present in the first frequency band from the second signal.
